(19) United States
(12) Patent Application Publication
(10) Pub. No.: US 2021/0254987 A1
(43) Pub. Date: Aug. 19, 2021

(54) ROUTE NAVIGATION DEVICE AND COMPUTER READABLE STORAGE MEDIUM

(71) Applicant: HONDA MOTOR CO.,LTD., Tokyo (JP)

(72) Inventor: Tomohiro SHIBATA, Saitama (JP)

(21) Appl. No.: 17/159,145

(22) Filed: Jan. 27, 2021

(30) Foreign Application Priority Data
Feb. 18, 2020 (JP) 2020-025629

(51) Int. Cl. G01C 21/34; G01C 21/36

(52) U.S. Cl. CPC G01C 21/3469; G01C 21/3476; G01C 21/3697; G01C 21/3679

(57) ABSTRACT

A route navigation device is provided, which includes a route determining unit configured to determine a scheduled travelling route of an electric vehicle; a battery information acquiring unit configured to acquire battery information indicating a remaining capacity of a battery of each of a plurality of other electric vehicles travelling at least a part of the scheduled travelling route; and a route navigation executing unit configured to execute route navigation for the electric vehicle based on the battery information of the plurality of other electric vehicles.

### BACKGROUND

### 1. Technical Field

The present invention relates to a route navigation device and a computer readable storage medium.

### 2. Related Art

Patent document 1 describes a congestion condition display device for displaying a congestion condition of a charge spot to an electric vehicle. Patent document 2 describes a technique for calculating a probability that the SOC (State Of Charge) will be depleted in a traffic jam and determining whether to circumvent the traffic jam. Patent document 3 describes a technique for acquiring scheduled travelling routes of a plurality of vehicles and planning a convoy travelling

### PRIOR ART DOCUMENTS

### Patent Documents

[Patent document 1] Japanese Patent Application Publication No. 2016-218647
[Patent document 2] Japanese Patent Application Publication No. 2013-242264
[Patent document 3] Japanese Patent Application Publication No. 2013-181775

### BRIEF DESCRIPTION OF THE DRAWINGS

FIG. 1 schematically shows one example of a system 10.

FIG. 2 schematically shows one example of a recommended route selection processing by an in-vehicle device 200.

FIG. 3 schematically shows one example of a functional configuration of the in-vehicle device 200.

FIG. 4 schematically shows one example of a scheduled travelling route 500.

FIG. 5 schematically shows one example of a processing flow by the in-vehicle device 200.

FIG. 6 schematically shows one example of route navigation by a route navigation executing unit 210.

FIG. 7 schematically shows one example of a functional configuration of a management server 300.

FIG. 8 schematically shows one example of a hardware configuration of a computer 1200 configured to function as the in-vehicle device 200 or the management server 300.

### DESCRIPTION OF EXEMPLARY EMBODIMENTS

Hereinafter, the present invention will be described through the embodiments of the invention. However, the embodiments described below do not limit the invention according to the claims. In addition, not all combinations of features described in the embodiments are necessarily required for solutions of the invention.

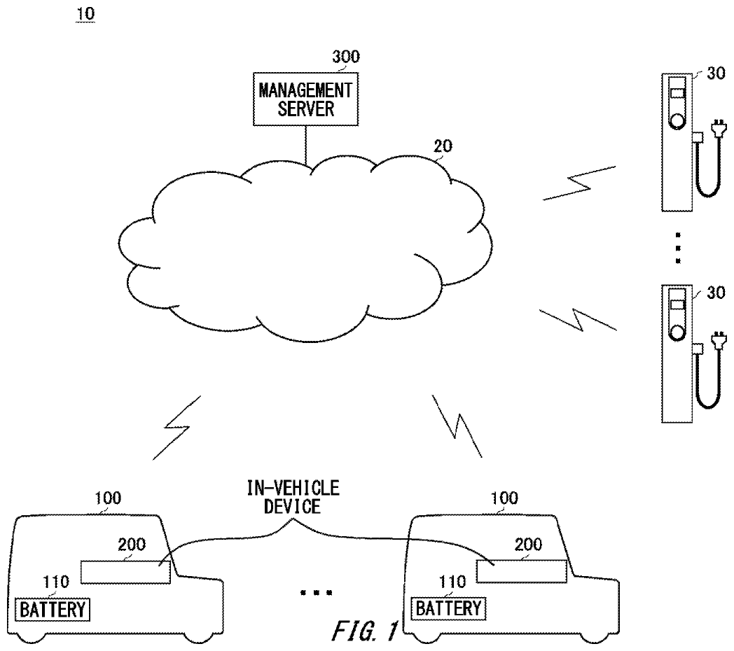

FIG. 1 schematically shows one example of a system 10. The system 10 includes in-vehicle devices 200 and a management server 300. The system 10 may include electric vehicles 100. The system 10 may include charge stands 30.

Each of the in-vehicle devices 200 is mounted in one of the electric vehicles 100. The electric vehicle 100 includes a battery 110. The electric vehicle 100 is a vehicle that can travel by using electrical power from the battery 110. The electric vehicle 100 is a vehicle that can charge the battery 110 by one of the charge stands 30. For example, the electric vehicle 100 is configured to receive electrical power from the charge stand 30 via a charge plug of the charge stand 30, and charge the battery 110.

The management server 300 is configured to collect information related to the electric vehicle 100 from the in-vehicle device 200. The management server 300 may collect information related to the electric vehicle 100 from the in-vehicle device 200 via a network 20.

The network 20 may be any network. For example, the network 20 includes a mobile communication network such as the so-called 3G (3rd Generation), LTE (Long Term Evolution), 4G (4th Generation), and 5G (5th Generation). The network 20 may include the so-called WiFi (Wireless Fidelity) network. The network 20 may include the Internet.

The information related to the electric vehicle 100 may include location information indicating a location of the electric vehicle 100. The information related to the electric vehicle 100 may include battery information indicating a remaining capacity of the battery 110. For example, the battery information indicates a SOC (State Of Charge). The information related to the electric vehicle 100 may include destination information indicating a destination of the electric vehicle 100. The information related to the electric vehicle 100 may include scheduled travelling route information indicating a scheduled travelling route of the electric vehicle 100. For example, the scheduled travelling route information of the electric vehicle 100 may be route information that is set in a navigation system of the electric vehicle 100.

The information related to the electric vehicle 100 may include a charge characteristic of an occupant of the electric vehicle 100. The charge characteristic may indicate a relationship between a remaining capacity of the battery 110 of the electric vehicle 100 and a timing of executing charge of the battery 110. Some persons will execute charge when the remaining capacity of the battery becomes around half, while other persons will not execute charge until the remaining capacity of the battery becomes around ⅕, and so on. Thus, a timing of executing charge is different from individual to individual. The charge characteristic represents such difference among individuals. For example, the electric vehicle 100 is configured to record the remaining capacity of the battery 110 when the charge of the battery 110 is executed, derive a charge characteristic at any timing, and send the charge characteristic to the management server 300.

The management server 300 is configured to collect information related to the charge stand 30 from the charge stand 30. The information related to the charge stand 30 may include location information indicating a location of the charge stand 30. The information related to the charge stand 30 may include the possible number of simultaneous charge. For example, the possible number of simultaneous charge is the number of charge connectors. The information related to the charge stand 30 may include charge capability information indicating a charge capability. For example, the charge capability may be a chargeable amount per unit time. The information related to the charge stand 30 may include congestion information indicating a congestion condition of the charge stand 30. For example, the congestion information may be the number of waiting vehicles. In addition, the congestion information may be information such as congested, normal, vacant.

The in-vehicle device 200 according to the present embodiment is configured to determine a scheduled travelling route of the electric vehicle 100 (which may be described as the own vehicle) in which the in-vehicle device 200 is mounted, acquire the battery information indicating the remaining capacity of the battery 110 of each of a plurality of other electric vehicles 100 (which may be described as the other vehicles) travelling at least a part of the scheduled travelling route, and execute route navigation for the own vehicle based on the acquired battery information. The in-vehicle device 200 may be one example of a route navigation device. The in-vehicle device 200 may receive the battery information of the other vehicles from the management server 300.

The scheduled travelling route of the own vehicle may be a route to a destination that is set in a navigation for the own vehicle. In addition, the scheduled travelling route may be a recommended route selected from a plurality of candidate routes to the destination of the own vehicle. In addition, the scheduled travelling route may be a candidate route to the destination of the own vehicle.

The in-vehicle device 200 is configured to perform, as the route navigation, for example, for each of the plurality of candidate routes, display of an object indicating the route on which the congestion information of the charge stand 30 included in the route, as well as the number of other vehicles whose battery 110's remaining capacity is lower than a predetermined threshold, are reflected. This can cause the occupant of the own vehicle to recognize the congestion condition of the charge stand 30 at the present time and estimate a future change in the congestion condition of the charge stand 30, and can provide the occupant with information for selecting a route with a shorter wait time at the charge stand 30.

In addition, for example, the in-vehicle device 200 is configured to acquire battery information of the plurality of other vehicles for each of the plurality of candidate routes, and execute the route navigation by using a route selected based on the acquired battery information as the recommended route. This makes it possible to select the recommended route based on a future change estimation of the congestion condition of the charge stand 30 in addition to the congestion condition of the charge stand 30 at the present time, and recommend a route highly likely with a shorter wait time at the charge stand 30.

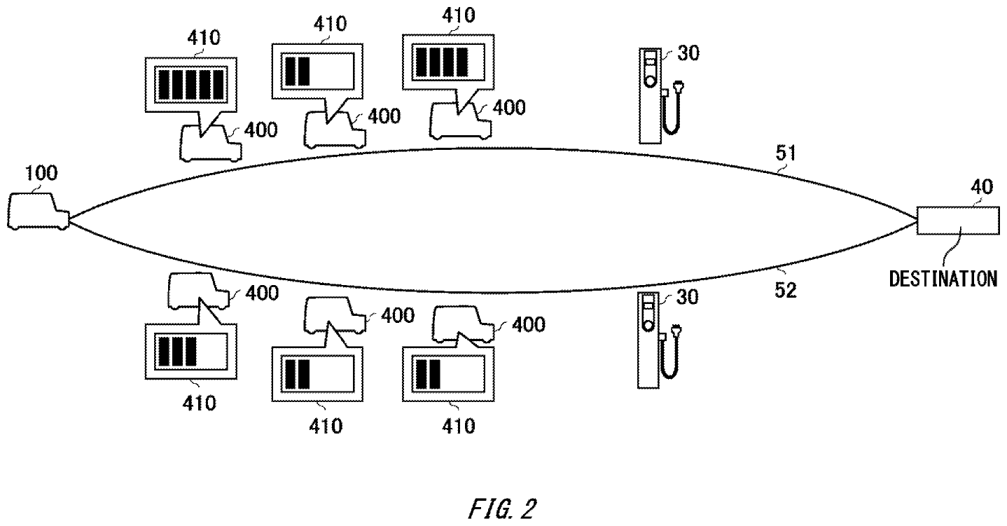

FIG. 2 schematically shows one example of a recommended route selection processing by an in-vehicle device 200. In FIG. 2, in order to simplify the description, a situation is described, as an example, where one charge stand 30 is included in each of a candidate route 51 and a candidate route 52, and three electric vehicles 400 are travelling on each of the candidate route 51 and the candidate route 52.

The in-vehicle device 200 mounted in the electric vehicle 100 is configured to receive, from the management server 300, for each of the candidate route 51 and the candidate route 52, location information and battery information of the electric vehicles 400 travelling the route and location information and congestion information of the charge stands 30. As is illustrated in FIG. 2, in the candidate route 51, the remaining capacity 410 of one of the three electric vehicles 400 is relatively low, and, in the candidate route 52, the remaining capacities 410 of all of the three electric vehicles 400 are relatively low.

For example, the in-vehicle device 200 is configured to judge whether the electric vehicles 400 will execute charge at the charge stand 30, based on the received information. Then, the in-vehicle device 200 is configured to estimate the congestion condition of the charge stand 30, based on the judgement result.

For example, in the example shown in FIG. 2, the in-vehicle device 200 judges that one electric vehicle 400 will execute charge at the charge stand 30 in the candidate route 51, and judges that three electric vehicles 400 will execute charge at the charge stand 30 in the candidate route 52. The in-vehicle device 200 estimates, for the candidate route 51, a congestion condition of the charge stand 30 at the time when the electric vehicle 100 arrives the charge stand 30, based on the current congestion condition of the charge stand 30 and the judgement result that one electric vehicle 400 will execute charge in the future. In addition, the in-vehicle device 200 estimates, for the candidate route 52, a congestion condition of the charge stand 30 at the time when the electric vehicle 100 arrives the charge stand 30, based on the current congestion condition of the charge stand 30 and the judgement result that three electric vehicles 400 will execute charge in the future.

For example, the in-vehicle device 200 is configured to estimate a wait time and a charge time at the charge stand 30 based on the prediction result for each of the candidate route 51 and the candidate route 52, and derive an estimated arrival time to the destination 40 of each of the candidate route 51 and the candidate route 52 based on the estimation result. Then, the in-vehicle device 200 is configured to execute the route navigation by using a route with an earlier predicted arrival time among the candidate route 51 and the candidate route 52 as the recommended route.

In the example shown in FIG. 2, assuming that three electric vehicles 400 are waiting at the charge stand 30 in the candidate route 51 and two electric vehicles 400 are waiting at the charge stand 30 in the candidate route 52, when the recommended route is selected referring only to the current congestion condition of the charge stand 30, the candidate route 52 will be selected. However, this may result in the wait time at the charge stand 30 being shorter in the candidate route 51, because one electric vehicle 400 will execute charge at the charge stand 30 in the candidate route 51 and three electric vehicles 400 will execute charge at the charge stand 30 in the candidate route 52. In contrast, with the in-vehicle device 200 according to the present embodiment, the route navigation considering the future congestion condition of the charge stand 30 can be executed by referring to the remaining capacity of the battery of each of the electric vehicles 400 travelling at least a part of the routes.

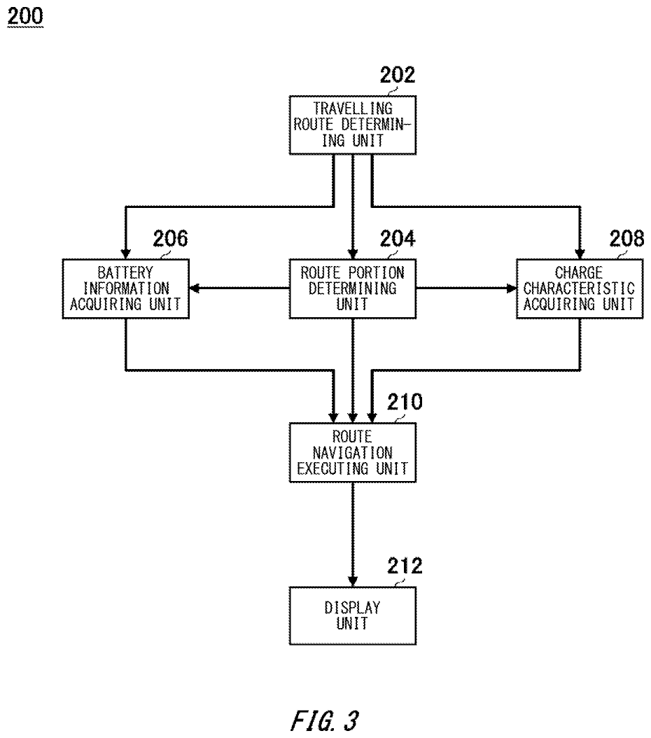

FIG. 3 schematically shows one example of a functional configuration of the in-vehicle device 200. The in-vehicle device 200 includes a travelling route determining unit 202, a route portion determining unit 204, a battery information acquiring unit 206, a charge characteristic acquiring unit 208, a route navigation executing unit 210, and a display unit 212.

The travelling route determining unit 202 is configured to determine a scheduled travelling route of the own vehicle. For example, the travelling route determining unit 202 is configured to determine a set route to a destination that is set in the navigation system of the own vehicle as the scheduled travelling route. In addition, for example, the travelling route determining unit 202 is configured to determine a plurality of candidate routes to the destination of the own vehicle as the scheduled travelling route. In addition, for example, the travelling route determining unit 202 is configured to determine a recommended route selected from the plurality of candidate routes as the scheduled travelling route.

The route portion determining unit 204 is configured to determine a charge requiring portion within the scheduled travelling route determined by the travelling route determining unit 202 in which the own vehicle becomes a charge requiring state, based on the remaining capacity of the battery 110 of the own vehicle. For example, the route portion determining unit 204 is configured to estimate a location on the scheduled travelling route at which the remaining capacity of the battery 110 will be lower than a predetermined threshold when the own vehicle travels the scheduled travelling route, and determine the portion after the estimated location on the scheduled travelling route as the charge requiring portion. The route portion determining unit 204 may determine the portion from the location on the scheduled travelling route at which the remaining capacity of the battery 110 will be lower than a predetermined threshold when the own vehicle travels the scheduled travelling route to the location at which the remaining capacity of the battery 110 will be depleted as the charge requiring portion.

The battery information acquiring unit 206 is configured to acquire battery information of the plurality of other vehicles travelling at least a part of the scheduled travelling route determined by the travelling route determining unit 202. The battery information acquiring unit 206 may receive the battery information of the other vehicles from the management server 300.

For example, the battery information acquiring unit 206 is configured to inform the management server 300 about the scheduled travelling route of the own vehicle determined by the travelling route determining unit 202, and receive, from the management server 300, the battery information of the plurality of other vehicles whose scheduled travelling route overlaps with at least a part of the scheduled travelling route of the own vehicle. In addition, for example, the battery information acquiring unit 206 is configured to inform the management server 300 about the charge requiring portion determined by the route portion determining unit 204, and receive, from the management server 300, the battery information of the plurality of other vehicles whose scheduled travelling route overlaps with at least a part of the charge requiring portion.

The charge characteristic acquiring unit 208 is configured to acquire a charge characteristic of an occupant of each of the plurality of other vehicles travelling at least a part of the scheduled travelling route determined by the travelling route determining unit 202. The charge characteristic acquiring unit 208 may receive the charge characteristic of the occupant of each of the other vehicles from the management server 300.

For example, the charge characteristic acquiring unit 208 is configured to inform the management server 300 about the scheduled travelling route of the own vehicle determined by the travelling route determining unit 202, and receive, from the management server 300, the charge characteristic of the occupant of each of the plurality of other vehicles whose scheduled travelling route overlaps with at least a part of the scheduled travelling route of the own vehicle. In addition, for example, the charge characteristic acquiring unit 208 is configured to inform the management server 300 about the charge requiring portion determined by the route portion determining unit 204, and receive, from the management server 300, the charge characteristic of the occupant of each of the plurality of other vehicles whose scheduled travelling route overlaps with at least a part of the charge requiring portion.

The route navigation executing unit 210 is configured to execute route navigation for the own vehicle. The route navigation executing unit 210 may execute the route navigation for the own vehicle based on the battery information acquired by the battery information acquiring unit 206. The route navigation executing unit 210 may execute the route navigation by using a display output and an audio output by the display unit 212.

The route navigation may include providing information related to the set route to the destination to the occupant the own vehicle. The information related to the set route may include information of the charge stand 30 on the set route. The information related to the set route may include information of the other vehicles travelling at least a part of the set route. The route navigation may include selecting a recommended route from a plurality of candidate routes to the destination of the own vehicle. The route navigation may include providing the occupant of the own vehicle with information of the recommended route selected from the plurality of candidate routes. The route navigation may include providing the occupant of the own vehicle with information of the plurality of candidate routes.

For example, the route navigation executing unit 210 is configured to provide information related to the number of other vehicles travelling at least a part of the scheduled travelling route whose battery's remaining capacity is lower than a predetermined threshold (which may be described as the number of low SOC vehicles), in combination with information of the scheduled travelling route of the own vehicle. In addition, for example, the route navigation executing unit 210 is configured to derive a predicted congestion degree of the charge stand 30 included in the scheduled travelling route of the own vehicle based on the battery information, and provide information related to the predicted congestion degree of the charge stand 30 included in the scheduled travelling route, in combination with information of the scheduled travelling route of the own vehicle.

The route navigation executing unit 210 may select a recommended route from a plurality of candidate routes based on the number of low SOC vehicles in each of the plurality of candidate routes to the destination of the own vehicle. In addition, the route navigation executing unit 210 may derive the predicted congestion degree of the charge stand 30 included in the route for each of the plurality of candidate routes to the destination of the own vehicle based on the battery information, and select the recommended route from the plurality of candidate routes based on the predicted congestion degree. The route navigation executing unit 210 may provide the number of low SOC vehicles in the recommended route and the predicted congestion degree of the charge stand 30 included in the recommended route, in combination with information of the recommended route.

The route navigation executing unit 210 may provide information related to the number of low SOC vehicles in combination with information of the route for each of the plurality of candidate routes to the destination of the own vehicle. In addition, the route navigation executing unit 210 may derive a predicted congestion degree of the charge stand 30 included in the route based on the battery information for each of the candidate routes to the destination of the own vehicle, and provide the predicted congestion degree in combination with the information of the route.

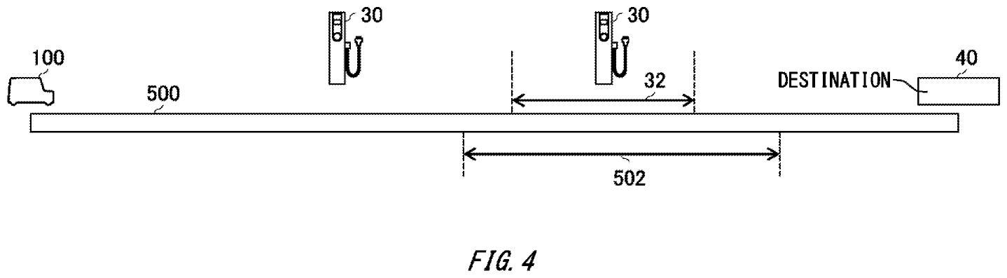

FIG. 4 schematically shows one example of a charge requiring portion 502 in a scheduled travelling route 500. The route navigation executing unit 210 may derive a predicted congestion degree of the charge stand 30 based on the number of low SOC vehicles within a predetermined range 32 in reference to the location of the charge stand 30 included in the charge requiring portion 502. For example, the range 32 may be a range determined by a predetermined distance in reference to the location of the charge stand 30. The range 32 may be arbitrarily settable. In a case where a plurality of charge stands 30 are included in the charge requiring portion 502, the route navigation executing unit 210 may derive a predicted congestion degree of each of the plurality of charge stands 30.

For example, the route navigation executing unit 210 is configured to derive the predicted congestion degree of the charge stand 30 such that, the larger the number of low SOC vehicles is, the higher the predicted congestion degree of the charge stand 30 becomes. For example, the route navigation executing unit 210 is configured to derive the predicted congestion degree of the charge stand 30 from the number of low SOC vehicles and the current congestion condition of the charge stand 30, assuming that the electric vehicles 400 corresponding to the number of low SOC vehicles will charge at the charge stand 30.

As a specific example, the route navigation executing unit 210 is configured to derive the predicted congestion degree of the charge stand 30 by estimating the waiting number at the time when the own vehicle arrives the charge stand 30 from the current congestion condition of the charge stand 30, and adding the estimated waiting number to the number of low SOC vehicles. The route navigation executing unit 210 may derive the predicted congestion degree of the charge stand 30, assuming that other vehicles of the number obtained by multiplying the number of low SOC vehicles by a predetermined coefficient will charge at the charge stand 30.

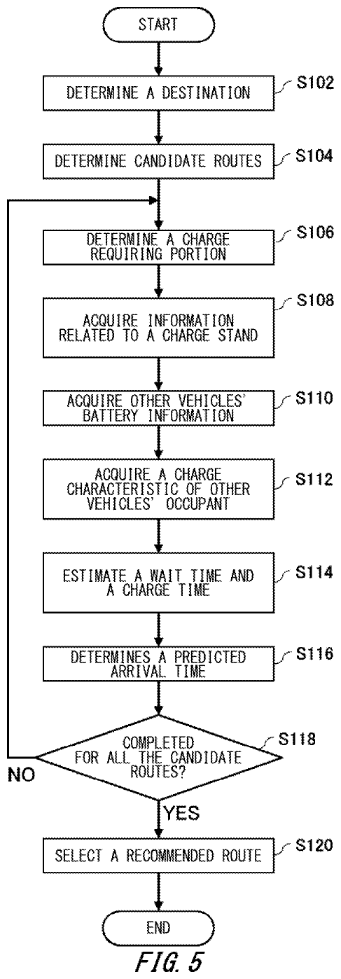

FIG. 5 schematically shows one example of a processing flow by the in-vehicle device 200. Here, a processing flow is described in which the route navigation executing unit 210 selects a recommended route from a plurality of candidate routes to the destination of the own vehicle, based on the battery information acquired by the battery information acquiring unit 206 and the charge characteristic acquired by the charge characteristic acquiring unit 208.

At Step (Step may be abbreviated as S) 102, the travelling route determining unit 202 determines a destination of the own vehicle. For example, the travelling route determining unit 202 determines the destination of the own vehicle by receiving a designation by an occupant of the own vehicle.

At S104, the travelling route determining unit 202 determines a plurality of candidate routes to the destination of the own vehicle. The travelling route determining unit 202 may determine the plurality of candidate routes by a similar method to a determining method of an existing navigation system.

At S106, the route portion determining unit 204 determines a charge requiring portion for one of the plurality of candidate routes determined at S104, based on the remaining capacity of the battery of the own vehicle. At S108, the route portion determining unit 204 acquires, from the management server 300, information related to a charge stand 30 included in the charge requiring portion determined at S106.

At S110, the battery information acquiring unit 206 acquires, from the management server 300, battery information of other vehicles whose scheduled travelling route overlaps with at least part of the charge requiring portion determined at S106. At S112, the charge characteristic acquiring unit 208 acquires, from the management server 300, a charge characteristic of an occupant of each of the plurality of other vehicles whose scheduled travelling route overlaps with at least a part of the charge requiring portion determined at S106.

At S114, the route navigation executing unit 210 estimates a wait time and a charge time at the charge stand 30, based on the information related to the charge stand 30 acquired by the route portion determining unit 204 at S108, the battery information acquired by the battery information acquiring unit 206 at S110, and the charge characteristic acquired by the charge characteristic acquiring unit 208 at S112. In a case where a plurality of charge stands 30 are included in the charge requiring portion determined at S106, the route navigation executing unit 210 may estimate the wait time and the charge time for each of the plurality of charge stands 30.

At S116, the route navigation executing unit 210 determines a predicted arrival time to the destination determined at S102, based on the wait time and the charge time estimated at S114. In a case where a plurality of charge stands 30 are included in the charge requiring portion determined at S106, the route navigation executing unit 210 may determine the predicted arrival time to the destination, assuming that the charge stand 30 with the least total time of the wait time and the charge time will be used.

At S118, the in-vehicle device 200 judges whether the determination of the predicted arrival time is completed for all of the plurality of candidate routes determined at S104. When the determination is not completed, the process returns to S106, and when the determination is completed, the process proceeds to S120. At S120, the route navigation executing unit 210 selects a recommended route from the plurality of candidate routes, based on the predicted arrival time determined for each of the plurality of candidate routes determined at S104.

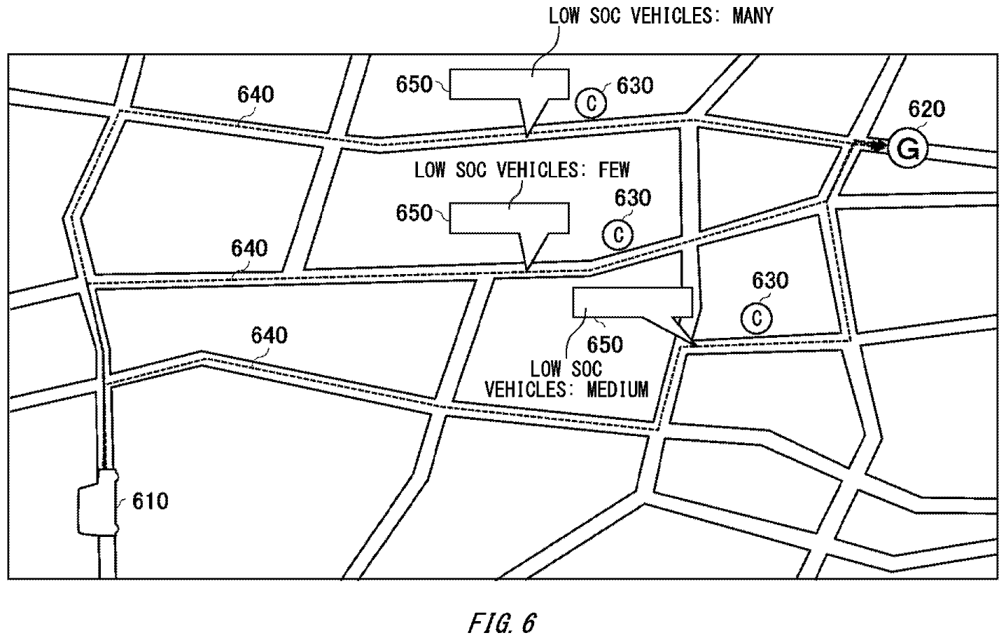

FIG. 6 schematically shows one example of route navigation by a route navigation executing unit 210. In FIG. 6, route navigation is described which performs display of each of the plurality of candidate routes to the destination on which the number of low SOC vehicles is reflected.

The route navigation executing unit 210 may provide display including an own vehicle object 610 for indicating the own vehicle, a destination object 620 for indicating the destination, a charge stand object 630 for indicating the charge stand, a candidate route object 640 for indicating the candidate route, an other vehicles information object 650 on which the number of low SOC vehicles in the candidate route is reflected.

In FIG. 6, a case is shown, as an example, where the other vehicles information object 650 indicates that the number of low SOC vehicles is large, medium, or small, but it is not limited thereto. The other vehicles information object 650 may indicate the number of low SOC vehicles in numerals.

The route navigation executing unit 210 may cause display of the candidate route object 640 according to the number of low SOC vehicles, instead of the display of the other vehicles information object 650 or along with the display of the other vehicles information object 650. For example, the route navigation executing unit 210 causes display of the candidate route object 640 more emphasized as the number of low SOC vehicles is larger. In addition, for example, the route navigation executing unit 210 may cause display of the candidate route object 640 more emphasized as the number of low SOC vehicles is smaller.

The route navigation executing unit 210 may cause display of the predicted congestion degree object for indicating the predicted congestion degree of the charge stand object 630, instead of the display of the other vehicles information object 650 or along with the display of the other vehicles information object 650. For example, the predicted congestion degree object indicates that the predicted congestion degree is high, medium, or low. The route navigation executing unit 210 may cause display of the charge stand object 630 more emphasized as the predicted congestion degree is higher. In addition, the route navigation executing unit 210 may cause display of the charge stand object 630 more emphasized as the predicted congestion degree is lower.

In FIG. 1 to FIG. 6, a case is described, as an example, where the in-vehicle device 200 mainly executes the route navigation, but it is not limited thereto. The management server 300 may mainly execute the route navigation.

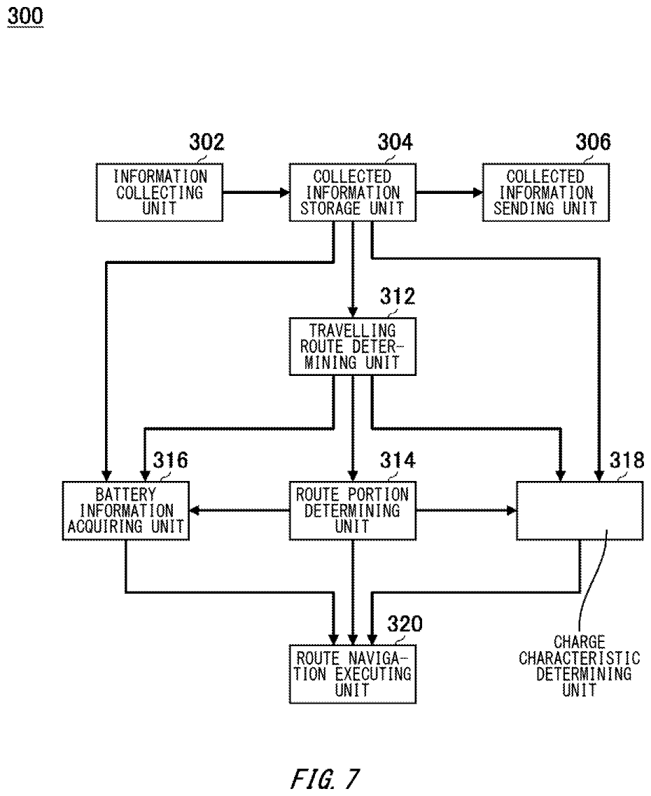

FIG. 7 schematically shows one example of a functional configuration of the management server 300. The management server 300 includes a information collecting unit 302, a collected information storage unit 304, a collected information sending unit 306, a travelling route determining unit 312, a route portion determining unit 314, a battery information acquiring unit 316, a charge characteristic acquiring unit 318, and a route navigation executing unit 320. The management server 300 may be one example of the route navigation device.

The information collecting unit 302 is configured to collect various types of information. The information collecting unit 302 is configured to collect information related to the electric vehicle 100 from the electric vehicle 100. In addition, the information collecting unit 302 is configured to collect information related to the charge stand 30 from the charge stand 30. The information collecting unit 302 is configured to store the collected information in the collected information storage unit 304. The information collecting unit 302 may store a value estimated from information acquired from the electric vehicle 100 in the past as required information from the electric vehicle 100 in the collected information storage unit 304. For example, the information collecting unit 302 is configured to store a value estimated by using a statistical value of the past travelling data of the electric vehicle 100 in the collected information storage unit 304.

The collected information sending unit 306 is configured to send the collected information stored in the collected information storage unit 304 to the in-vehicle device 200. The collected information sending unit 306 may send the various types of collected information to the in-vehicle device 200 in response to a request from the in-vehicle device 200.

The travelling route determining unit 312 is configured to determine a scheduled travelling route of the electric vehicle 100 that will be a target of executing the route navigation (which may be described as the target vehicle). The determining method may be similar to that of the travelling route determining unit 202.

The route portion determining unit 314 is configured to determine a charge requiring portion within the scheduled travelling route determined by the travelling route determining unit 312 in which the target vehicle becomes a charge requiring state, based on the remaining capacity of the battery 110 of the target vehicle. The determining method may be similar to that of the route portion determining unit 204.

The battery information acquiring unit 316 is configured to acquire battery information of the plurality of other vehicles, which are different from the target vehicle, travelling at least a part of the scheduled travelling route determined by the travelling route determining unit 312. The battery information acquiring unit 316 may acquire the battery information from the collected information storage unit 304.

The charge characteristic acquiring unit 318 is configured to acquire a charge characteristic of an occupant of each of the plurality of other vehicles, which are different from the target vehicle, travelling at least a part of the scheduled travelling route determined by the travelling route determining unit 312. The charge characteristic acquiring unit 318 may acquire the charge characteristic from the collected information storage unit 304.

The route navigation executing unit 210 is configured to execute route navigation for the target vehicle. The route navigation executing unit 210 may execute the route navigation for the target vehicle, based on the battery information acquired by the battery information acquiring unit 316. The route navigation executing unit 210 may execute the route navigation for the target vehicle by sending display data or sending a display instruction to the target vehicle.

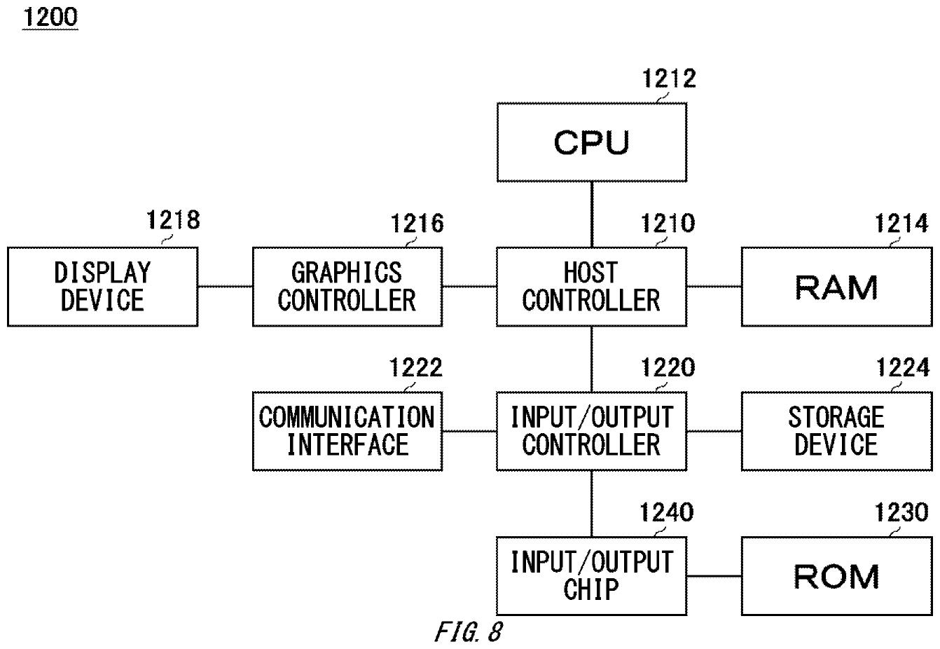

FIG. 8 schematically shows one example of a hardware configuration of a computer 1200 configured to function as the in-vehicle device 200 or the management server 300. A program that is installed in the computer 1200 can cause the computer 1200 to function as one or more “units” of apparatuses of the present embodiments or perform operations associated with the apparatuses of the present embodiments or the one or more units, and/or can cause the computer 1200 to perform processes of the present embodiments or steps thereof. Such a program may be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, and a graphics controller 1216, which are mutually connected by a host controller 1210. The computer 1200 also includes input/output units such as a communication interface 1222, a storage device 1224, a DVD drive and an IC card drive, which are connected to the host controller 1210 via an input/output controller 1220. The DVD drive may be a DVD-ROM drive, a DVD-RAM drive, etc. The storage device 1224 may be a hard disk drive, a solid-state drive, etc. The computer 1200 also includes legacy input/output units such as a ROM 1230 and a keyboard, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on a display device 1218.

The communication interface 1222 communicates with other electronic devices via a network. The storage device 1224 stores programs and data used by the CPU 1212 within the computer 1200. The DVD drive reads the programs or the data from the DVD-ROM or the like, and provides the storage device 1224 with the programs or the data. The IC card drive reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port or the like to the input/output controller 1220.

A program is provided by a computer readable storage medium such as the DVD-ROM or the IC card. The program is read from the computer readable storage medium, installed into the storage device 1224, RAM 1214, or ROM 1230, which are also examples of a computer readable storage medium, and executed by the CPU 1212. The information processing described in these programs is read into the computer 1200, resulting in cooperation between a program and the above-mentioned various types of hardware resources. An apparatus or method may be constituted by realizing the operation or processing of information in accordance with the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under control of the CPU 1212, reads transmission data stored on a transmission buffer region provided in a recording medium such as the RAM 1214, the storage device 1224, the DVD-ROM, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage device 1224, the DVD drive (DVD-ROM), the IC card, etc., and perform various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, information processing, condition judging, conditional branch, unconditional branch, search/replacement of information, etc., as described throughout this disclosure and designated by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search for an entry whose attribute value of the first attribute matches the condition a designated condition, from among the plurality of entries, and read the attribute value of the second attribute stored in the entry, thereby obtaining the attribute value of the second attribute associated with the first attribute satisfying the predetermined condition.

The above described program or software modules may be stored in the computer readable storage medium on or near the computer 1200. In addition, a recording medium such as a hard disk or a RAM provided in a server system connected to a dedicated communication network or the Internet can be used as the computer readable storage medium, thereby providing the program to the computer 1200 via the network.

Blocks in flowcharts and block diagrams in the present embodiments may represent steps of processes in which operations are performed or “units” of apparatuses responsible for performing operations. Certain steps and “units” may be implemented by dedicated circuitry, programmable circuitry supplied with computer readable instructions stored on a computer readable storage medium, and/or processors supplied with computer readable instructions stored on a computer readable storage medium. Dedicated circuitry may include digital and/or analog hardware circuits and may include integrated circuits (IC) and/or discrete circuits. For example, programmable circuitry may include reconfigurable hardware circuits including logical AND, OR, XOR, NAND, NOR, and other logical operations, flip-flops, registers, and memory elements, such as field-programmable gate arrays (FPGA), programmable logic arrays (PLA), etc.

A computer readable storage medium may include any tangible device that can store instructions for execution by a suitable device, such that the computer readable storage medium having instructions stored therein comprises an article of manufacture including instructions which can be executed to create means for performing operations specified in the flowcharts or block diagrams. Examples of the computer readable storage medium may include an electronic storage medium, a magnetic storage medium, an optical storage medium, an electromagnetic storage medium, a semiconductor storage medium, etc. More specific examples of the computer readable storage medium may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, etc.

Computer readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer readable instructions may be provided to a processor of a general purpose computer, special purpose computer, or other programmable data processing apparatus, or to programmable circuitry, locally or via a local area network (LAN), wide area network (WAN) such as the Internet, etc., so that the processor of the general purpose computer, special purpose computer, or other programmable data processing apparatus, or the programmable circuitry executes the computer readable instructions to create means for performing operations specified in the flowcharts or block diagrams. Examples of processors include computer processors, processing units, microprocessors, digital signal processors, controllers, microcontrollers, etc.

While the embodiments of the present invention have been described, the technical scope of the invention is not limited to the above described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: system, 20: network, 30: charge stand, 32: range, 40: destination, 51, 52: candidate route, 100: electric vehicle, 110: battery, 200: in-vehicle device, 202: travelling route determining unit, 204: route portion determining unit, 206: battery information acquiring unit, 208: charge characteristic acquiring unit, 210: route navigation executing unit, 300: management server, 302: information collecting unit, 304: collected information storage unit, 306: collected information sending unit, 312: travelling route determining unit, 314: route portion determining unit, 316: battery information acquiring unit, 318: charge characteristic acquiring unit, 320: route navigation executing unit, 400: electric vehicle, 500: scheduled travelling route, 502: charge requiring portion, 610: own vehicle object, 620: destination object, 630: charge stand object, 640: candidate route object, 650: other vehicles information object, 1200: computer, 1210: host controller, 1212: CPU, 1214: RAM, 1216: graphics controller, 1218: display device, 1220: input/output controller, 1222: communication interface, 1224: storage device, 1230: ROM, 1240: input/output chip

What is claimed is:

1. A route navigation device comprising:
a route determining unit configured to determine a scheduled travelling route of an electric vehicle;
a battery information acquiring unit configured to acquire battery information indicating a remaining capacity of a battery of each of a plurality of other electric vehicles travelling at least a part of the scheduled travelling route; and
a route navigation executing unit configured to execute route navigation for the electric vehicle based on the battery information of the plurality of other electric vehicles.

2. The route navigation device according to claim 1, wherein the route navigation executing unit is configured to execute the route navigation for the electric vehicle based on the battery information of the plurality of other electric vehicles whose scheduled travelling route overlaps with at least a part of the scheduled travelling route of the electric vehicle.

3. The route navigation device according to claim 2, comprising:
a route portion determining unit configured to determine a charge requiring portion within the scheduled travelling route of the electric vehicle in which the electric vehicle becomes a charge requiring state, based on a remaining capacity of a battery of the electric vehicle,
wherein the route navigation executing unit is configured to execute the route navigation for the electric vehicle based on the battery information of the plurality of other electric vehicles whose scheduled travelling route overlaps with at least a part of the charge requiring portion.

4. The route navigation device according to claim 1, wherein the route navigation executing unit is configured to derive an predicted congestion degree of a charge stand included in the scheduled travelling route of the electric vehicle based on the battery information of the plurality of other electric vehicles, and execute the route navigation for the electric vehicle based on the predicted congestion degree.

5. The route navigation device according to claim 2, wherein the route navigation executing unit is configured to derive an predicted congestion degree of a charge stand included in the scheduled travelling route of the electric vehicle based on the battery information of the plurality of other electric vehicles, and execute the route navigation for the electric vehicle based on the predicted congestion degree.

6. The route navigation device according to claim 3, wherein the route navigation executing unit is configured to derive an predicted congestion degree of a charge stand included in the scheduled travelling route of the electric vehicle based on the battery information of the plurality of other electric vehicles, and execute the route navigation for the electric vehicle based on the predicted congestion degree.

7. The route navigation device according to claim 4, wherein the route navigation executing unit is configured to derive the predicted congestion degree of the charge stand based on the number of electric vehicles whose battery's remaining capacity is lower than a predetermined threshold within a predetermined range in reference to a location of the charge stand.

8. The route navigation device according to claim 1,
wherein the battery information acquiring unit is configured to acquire the battery information of the plurality of other electric vehicles for each of plurality of candidate routes to a destination of the electric vehicle, and
the route navigation executing unit is configured to execute the route navigation for the electric vehicle by using a route, which is selected from the plurality of candidate routes based on the battery information of the plurality of other electric vehicles, as a recommended route.

9. The route navigation device according to claim 2,
wherein the battery information acquiring unit is configured to acquire the battery information of the plurality of other electric vehicles for each of plurality of candidate routes to a destination of the electric vehicle, and
the route navigation executing unit is configured to execute the route navigation for the electric vehicle by using a route, which is selected from the plurality of candidate routes based on the battery information of the plurality of other electric vehicles, as a recommended route.

10. The route navigation device according to claim 3,
wherein the battery information acquiring unit is configured to acquire the battery information of the plurality of other electric vehicles for each of plurality of candidate routes to a destination of the electric vehicle, and
the route navigation executing unit is configured to execute the route navigation for the electric vehicle by using a route, which is selected from the plurality of candidate routes based on the battery information of the plurality of other electric vehicles, as a recommended route.

11. The route navigation device according to claim 8, wherein the route navigation executing unit is configured to execute the route navigation for the electric vehicle by using a route, which is selected from the plurality of candidate routes based on a location of a charge stand included in each of the plurality of candidate routes and the battery information of the plurality of other electric vehicles, as the recommended route.

12. The route navigation device according to claim 11, wherein the route navigation executing unit is configured to execute the route navigation for the electric vehicle by using a route, which is selected from the plurality of candidate routes based on the location of the charge stand included in each of the plurality of candidate routes and a congestion condition as well as the battery information of the plurality of other electric vehicles, as the recommended route.

13. The route navigation device according to claim 8, wherein the route navigation executing unit is configured to estimate, for each route of the plurality of candidate routes, a wait time and a charge time at the charge stand within the route based on a congestion condition of the charge stand within the route and the battery information of the plurality of other electric vehicles travelling the route, and execute the route navigation for the electric vehicle by using a route, which is selected from the plurality of candidate routes based on the wait time and the charge time, as the recommended route.

14. The route navigation device according to claim 11, wherein the route navigation executing unit is configured to estimate, for each of the plurality of candidate routes, a wait time and a charge time at the charge stand within the route based on a congestion condition of charge stand within the route and the battery information of a plurality of other electric vehicles travelling a route, and execute the route navigation for the electric vehicle by using a route, which is selected from the plurality of candidate routes based on the wait time and the charge time, as the recommended route.

15. The route navigation device according to claim 12, wherein the route navigation executing unit is configured to estimate, for each of the plurality of candidate routes, a wait time and a charge time at the charge stand within the route based on a congestion condition of charge stand within the route and the battery information of a plurality of other electric vehicles travelling a route, and execute the route navigation for the electric vehicle by using a route, which is selected from the plurality of candidate routes based on the wait time and the charge time, as the recommended route.

16. The route navigation device according to claim 13, comprising:
a charge characteristic acquiring unit configured to acquire, for each route of the plurality of candidate routes, a charge characteristic indicating a relationship between the remaining capacity of a battery of each of the other electric vehicles and a timing of executing charge of the battery concerning an occupant of each of the other electric vehicles travelling the route,
wherein the route navigation executing unit is configured to execute the route navigation for the electric vehicle by using a route, which is selected from the plurality of candidate routes further based on the charge characteristic, as the recommended route.

17. The route navigation device according to claim 1, wherein the route navigation executing unit is configured to control so as to perform display of the scheduled travelling route of the electric vehicle on which the battery information of the plurality of other electric vehicles is reflected.

18. The route navigation device according to claim 2, wherein the route navigation executing unit is configured to control so as to perform display of the scheduled travelling route of the electric vehicle on which the battery information of the plurality of other electric vehicles is reflected.

19. The route navigation device according to claim 17, wherein the route navigation executing unit is configured to control so as to perform display of an object indicating the scheduled travelling route of the electric vehicle on which the number of other electric vehicles whose battery's remaining capacity is lower than a predetermined threshold is reflected.

20. A non-transitory computer readable storage medium having stored thereon a program for causing a computer to function as:
a route determining unit configured to determine a scheduled travelling route of an electric vehicle;
a battery information acquiring unit configured to acquire battery information indicating a remaining capacity of a battery of each of a plurality of other electric vehicles travelling at least a part of the scheduled travelling route; and
a route navigation executing unit configured to execute route navigation for the electric vehicle based on the battery information of the plurality of other electric vehicles.
